(19) United States
(12) Patent Application Publication
(10) Pub. No.: US 2022/0411023 A1
(43) Pub. Date: Dec. 29, 2022

(54) BARGE FALL ARREST SYSTEM

(71) Applicant: KIRBY INLAND MARINE, LP, Houston, TX (US)

(72) Inventor: Mike Dickerson, Dayton, TX (US)

(21) Appl. No.: 17/848,464

(22) Filed: Jun. 24, 2022

Related U.S. Application Data
(60) Provisional application No. 63/214,456, filed on Jun. 24, 2021.

(51) Int. Cl. B63B 17/04

(52) U.S. Cl. CPC B63B 17/04; B63B 2017/045

(57) ABSTRACT

A fall arrest system for a barge includes an anchor point mechanically coupled to the deck of the barge. The anchor point includes an attachment point. The fall arrest system includes a lifeline extending along a bulkhead of the barge. The fall arrest system includes a fixed cable anchor. The fixed cable anchor may be mechanically coupled to the bulkhead. The fixed cable anchor may include a hole to which the lifeline is mechanically coupled. The fall arrest system includes an intermediate bracket. The intermediate bracket may be mechanically coupled to the bulkhead. The intermediate bracket may include a cable guide through which the lifeline extends and may pass through.

### CROSS-REFERENCE TO RELATED APPLICATIONS

This application is a nonprovisional application which claims priority from U.S. provisional application No. 63/214,456, filed Jun. 24, 2021, which is hereby incorporated by reference herein in its entirety.

### TECHNICAL FIELD/FIELD OF THE DISCLOSURE

The present disclosure relates generally to safety systems, and specifically to safety systems for barges.

### BACKGROUND OF THE DISCLOSURE

Barges are typically used for the transport of goods along inland waterways. Inland barges may operate in rivers and other narrow-access waterways. For the ease of loading, inland barges typically do not include safety rails and often are difficult for personnel operating on the barge to traverse owing to lading and configurations of barges. For example, inland tank barges typically have one or more large, centrally located tanks on the barge surface, allowing only a narrow walking deck about the perimeter of the barge. Operating at or near the gunwales or edges of the barge presents a risk of falls onto the barge and a risk of falling overboard for barge personnel.

### SUMMARY

The present disclosure provides for a fall arrest system for a barge. The fall arrest system may include a lifeline extending along a bulkhead of the barge. The fall arrest system may include a fixed cable anchor. The fixed cable anchor may be mechanically coupled to the bulkhead. The fixed cable anchor may include a hole to which the lifeline is mechanically coupled. The fall arrest system may include an intermediate bracket. The intermediate bracket may be mechanically coupled to the bulkhead. The intermediate bracket may include a cable guide through which the lifeline extends and may pass through.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a perspective view of a barge including a barge fall arrest system consistent with at least one embodiment of the present disclosure.

FIG. 2 is a top view of the barge of FIG. 1.

FIG. 3 is a perspective view of an anchor point of a barge fall arrest system consistent with at least one embodiment of the present disclosure.

FIG. 4 is a perspective view of a cable anchor bracket consistent with at least one embodiment of the present disclosure.

FIG. 5 is a perspective view of an intermediate cable bracket consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

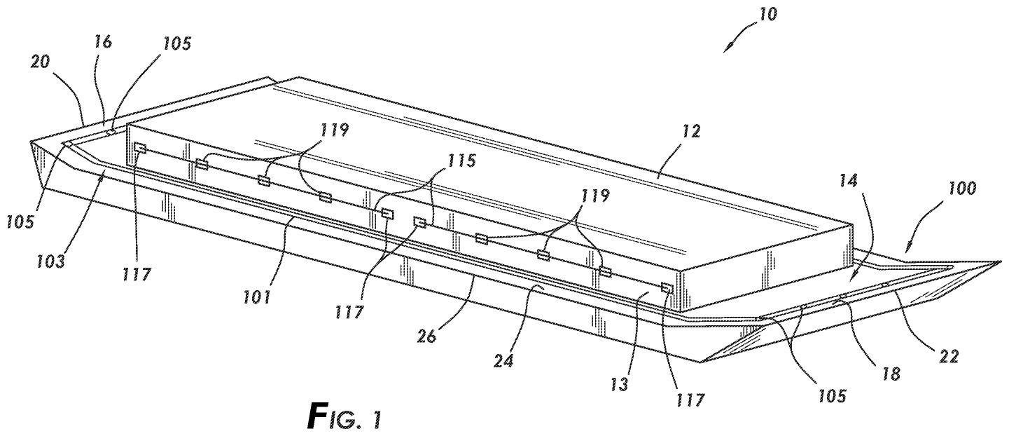

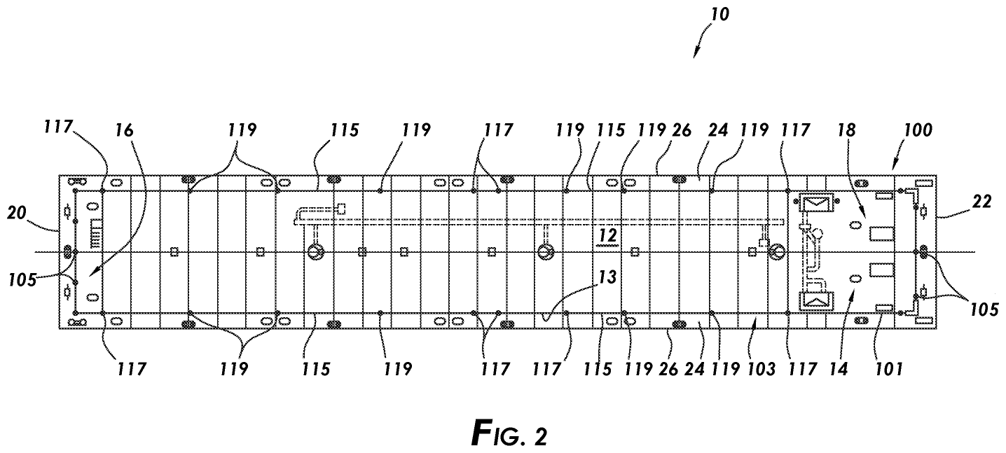

FIGS. 1 and 2 depict barge 10. Barge 10 may be an inland barge such as an inland tank barge. Barge 10 may include tank 12 positioned substantially centrally on barge 10. In other embodiments, barge 10 may include a cargo area in place of tank 12. In some embodiments, the side of tank 12 or other components of barge 10 may form bulkhead 13. Barge 10 may include deck 14. Deck 14 may be a substantially flat surface upon which barge personnel may traverse. Deck 14 may include foredeck 16 and afterdeck 18. Foredeck 16 may extend between tank 12 and bow 20 of barge 10. Afterdeck 18 may extend between tank 12 and aft 22 of barge 10. In some embodiments, walking deck 24 may extend port and starboard of bulkhead 13 to gunwales 26 of barge 10.

Barge 10 may include fall arrest system 100. Fall arrest system 100 may, for example and without limitation, include one or more apparatuses positioned to allow barge personnel to secure themselves to barge 10 while operating at or near the periphery of barge 10.

In some embodiments, fall arrest system 100 may include fall safety area demarcation line 101. Fall safety area demarcation line 101 may, in some embodiments, be a line painted on or otherwise coupled to barge 10. In some embodiments, fall safety area demarcation line 101 may be positioned a preselected distance, defined herein as a threshold distance, from the periphery of barge 10 to indicate to barge personnel their proximity to the perimeter of barge 10. For example and without limitation, in some embodiments, fall safety area demarcation line 101 may be positioned 3′ from the nearest edge of barge 10. The area of deck 14 between fall safety area demarcation line 101 and the nearest edge of barge 10 may define fall safety area 103.

In some embodiments, where deck 14 does not extend the threshold from the nearest periphery of barge 10, fall safety area demarcation line 101 may be positioned on deck 14 at the furthest point from the edge of barge 10. As a nonlimiting example, in a case where walking deck 24 is less than the threshold distance wide, such as where walking deck 24 is 2′6″ wide and the threshold distance is 3′, fall safety area demarcation line 101 may be positioned on walking deck 24 adjacent or nearly adjacent to tank 12, indicating that all of walking deck 24 is within fall safety area 103.

Barge personnel operating on deck 14 of barge 10 may wear fall arrest gear that may include, for example and without limitation, a harness and a lanyard or personal fall limiter (PFL). For the purposes of this disclosure, the fall arrest gear is referred to as a PFL. The PFL may include a clip apparatus such as a carabiner at the end thereof to allow the barge personnel to attach themselves to components of fall arrest system 100 as further described below. In some embodiments, while operating in fall safety area 103, personnel may be required to be attached to fall arrest system 100 using the PFL.

In some embodiments, fall arrest system 100 may include one or more anchor points 105. Anchor points 105 may be mechanically coupled to deck 14 of barge 10 and may provide a hardpoint for barge personnel to attach their PFL when operating in fall safety area 103. Anchor points 105 may be positioned at fall safety area demarcation line 101 or at a position proximate fall safety area demarcation line 101 outside of fall safety area 103 to allow barge personnel to couple their PFL thereto while remaining outside fall safety area 103. In some embodiments, anchor points 105 may be positioned at open areas of deck 14 such as at foredeck 16 and afterdeck 18. Anchor points 105 may be relatively low profile such that anchor points 105 present little or no tripping hazard to barge personnel.

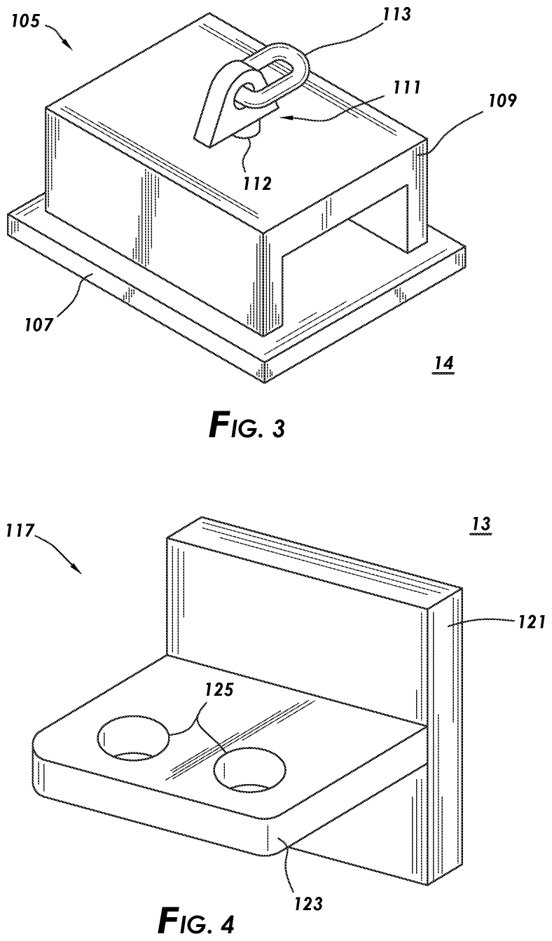

FIG. 3 depicts a perspective view of anchor point 105 consistent with at least one embodiment of the present disclosure. Anchor point 105 may include mounting plate 107. Mounting plate 107 may be used to couple anchor point 105 to deck 14. Mounting plate 107 may, for example and without limitation, be welded or bolted directly to deck 14 or other components of barge 10 fixedly coupled to deck 14 or the substructure of barge 10.

In some embodiments, anchor point 105 may include anchor bracket 109. Anchor bracket 109 may be coupled to mounting plate 107. Anchor point 105 may include attachment point 111 mechanically coupled to anchor bracket 109. In some embodiments, attachment point 111 may be a swivel 112. In some embodiments, attachment point 111 may include shackle 113. Shackle 113 may allow barge personnel to couple their PFL to anchor point 105. While operating in fall safety area 103 at or near anchor point 105, barge personnel may couple their PFL thereto in order to, for example and without limitation, reduce the risk of falling overboard in the event that a fall occurs.

With reference to FIGS. 1 and 2, fall arrest system 100 may include one or more lifelines 115. Lifelines 115 may be positioned such that barge personnel may couple their PFL thereto while operating in fall safety area 103 at a confined area of deck 14, such as when operating on or traversing walking deck 24. In some embodiments, lifelines 115 may be formed from wire rope. Lifelines 115 may extend between fixed cable anchors 117. Lifelines 115 may be rigidly coupled to fixed cable anchors 117.

In some embodiments, lifelines 115 may extend through intermediate brackets 119. Intermediate brackets 119 may retain lifelines 115 in a fixed position while allowing lifelines 115 to traverse therethrough while taking up loading forces in the event a fall occurs.

In some embodiments, lifelines 115 may be pretensioned to a desired degree between fixed cable anchors 117 to, for example and without limitation, provide the desired shock load capability and extension in the event one or more barge personnel experience a fall depending on the configuration and positioning of fixed cable anchors 117 and intermediate brackets 119 and the material and parameters of lifelines 115.

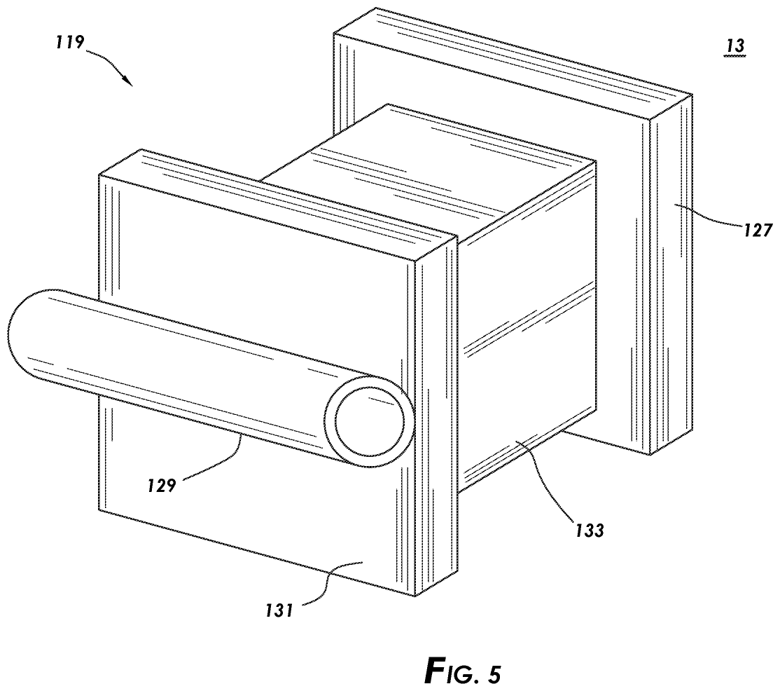

FIG. 4 depicts a perspective view of fixed cable anchor 117 consistent with at least one embodiment of the present disclosure. Fixed cable anchor 117 may include mounting plate 121. Mounting plate 121 may be used to couple fixed cable anchor 117 to bulkhead 13 or other raised area of barge 10. Mounting plate 121 may, for example and without limitation, be welded or bolted directly to bulkhead 13 or other components of barge 10. Fixed cable anchor 117 may include anchor plate 123.

Anchor plate 123 may include one or more holes 125 positioned to allow lifeline 115 to couple thereto. Holes 125 may be positioned on anchor plate 123 a distance from mounting plate 121 such that lifeline 115 couples to anchor plate 123 a desired distance, referred to herein as a standoff distance, from bulkhead 13, thereby preventing or reducing contact between lifeline 115 and bulkhead 13. The standoff distance may reduce the likelihood that friction between lifeline 115 and bulkhead 13 may impede proper operation of fall arrest system 100. Additionally, the standoff distance may allow for easier interaction between barge personnel and lifeline 115 while coupling a PFL thereto as compared to an embodiment in which lifeline 115 is proximate bulkhead 13.

FIG. 5 depicts a perspective view of intermediate bracket 119. Intermediate bracket 119 may include mounting plate 127. Mounting plate 127 may be used to couple intermediate bracket 119 to bulkhead 13 or other raised area of barge 10. Mounting plate 127 may, for example and without limitation, be welded or bolted directly to bulkhead 13 or other components of barge 10.

Intermediate bracket 119 may include cable guide 129. Cable guide 129 may be mechanically coupled to guide plate 131, which may be mechanically coupled to mounting plate 127. Cable guide 129 may be tubular such that lifeline 115 may pass therethrough. Cable guide 129 may allow lifeline 115 to remain in a fixed position relative to barge 10 while allowing lifeline 115 to pass therethrough in the event of an arrested fall, thereby localizing any non-aligned forces to intermediate bracket 119.

In some embodiments, intermediate bracket 119 may include standoff 133. Standoff 133 may extend between mounting plate 127 and guide plate 131 such that cable guide 129 is extended a desired distance from bulkhead 13, thereby preventing or reducing contact between lifeline 115 and bulkhead 13. The standoff distance may reduce the likelihood that friction between lifeline 115 and bulkhead 13 may impede proper operation of fall arrest system 100. Additionally, the standoff distance may allow for easier interaction between barge personnel and lifeline 115 while coupling a PFL thereto as compared to an embodiment in which lifeline 115 is proximate bulkhead 13.

In some embodiments, the spacing between fixed cable anchors 117 for a given lifeline 115, and therefore the overall length of lifeline 115, may be determined based on anticipated fall loads with reference to the material and diameter of lifeline 115. In some embodiments, for example and without limitation, fixed cable anchors 117 may be spaced no more than 100′ apart for a single lifeline 115. In some embodiments, the spacing between adjacent fixed cable anchors 117 and intermediate brackets 119 or between adjacent intermediate brackets 119 for a given lifeline 115 may be determined based on anticipated fall loads with reference to the material and diameter of lifeline 115. In some embodiments, for example and without limitation, the maximum distance between adjacent fixed cable anchors 117 and intermediate brackets 119 or between adjacent intermediate brackets 119 may be no more than 20′ apart for a single lifeline 115.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A fall arrest system for a barge comprising:
a lifeline, the lifeline extending along a bulkhead of the barge;
a fixed cable anchor, the fixed cable anchor mechanically coupled to the bulkhead, the fixed cable anchor including a hole to which the lifeline is mechanically coupled; and
an intermediate bracket, the intermediate bracket mechanically coupled to the bulkhead, the intermediate bracket including a cable guide through which the lifeline extends and may pass through.

2. The fall arrest system of claim 1, further comprising a fall safety area demarcation line, the fall safety area demarcation line positioned on the deck of the barge, the fall safety area demarcation line positioned a threshold distance from the periphery of the barge, the space between the fall safety area demarcation line and the periphery of the barge defining a fall safety area.

3. The fall arrest system of claim 2, wherein the lifeline is positioned outside the fall safety area.

4. The fall arrest system of claim 1, wherein the lifeline is a wire rope.

5. The fall arrest system of claim 1, further comprising an anchor point mechanically coupled to a deck of the barge, the anchor point including an attachment point.

6. The fall arrest system of claim 5, wherein the attachment point of the anchor point comprises a swivel.

7. The fall arrest system of claim 5, wherein the attachment point of the anchor point comprises a shackle.

8. The fall arrest system of claim 5, wherein the anchor point comprises a mounting plate and an anchor bracket, the mounting plate mechanically coupled to the deck of the barge, the anchor bracket mechanically coupled to the mounting plate, wherein the attachment point is coupled to the anchor bracket.

9. The fall arrest system of claim 5, further comprising a fall safety area demarcation line, the fall safety area demarcation line positioned on the deck of the barge, the fall safety area demarcation line positioned a threshold distance from the periphery of the barge, the space between the fall safety area demarcation line and the periphery of the barge defining a fall safety area, wherein the anchor point is positioned outside the fall safety area.

10. The fall arrest system of claim 1, wherein the fixed cable anchor comprises a mounting plate, the mounting plate mechanically coupled to the bulkhead.

11. The fall arrest system of claim 1, wherein the intermediate bracket comprises a mounting plate, the mounting plate mechanically coupled to the bulkhead, the cable guide mechanically coupled to the mounting plate.

12. The fall arrest system of claim 11, further comprising a guide plate, the guide plate mechanically coupled to the mounting plate, the cable guide mechanically coupled to the guide plate.

13. The fall arrest system of claim 12, wherein the guide plate is mechanically coupled to the mounting plate by a standoff.
